(19) United States
(12) Patent Application Publication
(10) Pub. No.: US 2007/0046441 A1
(43) Pub. Date: Mar. 1, 2007

(54) Gift-wrapping envelope

(76) Inventor: John McCormick, Appleton, WI (US)

Correspondence Address: Starkweather & Associates, Suite 200, 9035 South 1300 East, Sandy, UT, 84094, US

(21) Appl. No.: 11/213,539

(22) Filed: Aug. 25, 2005

(51) Int. Cl. G08B 3/00; B65D 65/38

(52) U.S. Cl. 340/384.1; 229/87.19

(57) ABSTRACT

A gift-wrapping envelope including: a face panel; a back panel integrally coupled with the face panel; an expandable side panel coupled to both the face and back panels; an enclosure panel integrally coupled to the face, back, or side panels and releasably couplable to one of the panels to which it is not integrally coupled; a nametag area; and a releasably couplable accessory area. The gift-wrapping envelope may include an audio label. The nametag panel may be erasably writable. The releasably couplable accessory area may include a release liner and/or a no-rip material. The expandable side panel may include accordion-type folds.

### BACKGROUND OF THE INVENTION

1. Field of the Invention

The present invention relates to gift-wrapping envelopes, specifically gift-wrapping envelopes with expandable side panels, a nametag area, a releasably couplable accessory area, and/or an audio label.

2. Description of the Related Art

U.S. Pat. No. 5,894,986 to Lederman, et al. discloses an inexpensive mailing envelope with a window opening to which a decorative image-bearing sheet member is attached. The image-bearing sheet member may be transparent or semi-opaque, partially revealing the contents of the said envelope. The inclusion of a decorative image visible from the outside of the envelope induces mailing recipients to open the envelope and examine the contents inserted therein. The window opening may be placed on the rear panel of the envelope, opposite the panel displaying address information. The image-bearing sheet material may be detachable and may be promoted as a gift.

A gift-wrapping envelope for packaging an information media disk holder that is formed of a decorative substrate is disclosed in U.S. Patent Application Publication No. 2003/0201313. The envelope is formed to be flat without overlapping corner folds that are typically found in a wrapped package when the package is empty. The gift-wrap envelope may also be used as a mailer.

Finally, U.S. Pat. No. 6,070,719 to Pollock discloses a greeting card and gift box combination made from a single sheet of cardboard-like box stock having a gift box member with a window for viewing a gift mounted therein, a greeting message on the gift box member above the window, a greeting card front flap hingedly attached to a side of the gift box member, an envelope cover integrated into the front flap to selectively hide a greeting or message viewable through a frame or window in the outside panel of the front flap, and a gift mount system for mounting a gift within the gift box member.

Several envelopes of the prior art are constructed such that they are easily moveable though the mail system. Such construction often results in envelopes that must be destroyed to open. Often envelopes must be written upon to, for example, indicate the intended recipient. Thus, re-use of the envelopes may be restricted. Gift boxes, bags, envelopes and the like may have accessories, such as bows, placed upon them. Upon removal of the accessory, the gift box, bag, envelope or the like may rip or be defaced.

What is needed is a gift-wrapping envelope that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available gift-wrapping envelopes. In one embodiment, the gift-wrapping envelope includes and envelope with a void, an enclosure section releasably couplable upon closure, a releasably couplable area releasably couplable to the enclosure section, an expandable section, an accessory releasably couplable area releasably couplable to an accessory, and/or a nametag area. The envelope may also include an audio label.

The nametag area may include an erasably writable surface or a pocket and a window.

The releasably couplable area releasably couplable to the enclosure section may include a hood-and-loop fastener.

The expandable section may include a fold extending substantially parallel to an edge of the gift-wrapping envelope.

The accessory releasably couplable area may include a non-rip material

In another embodiment, the gift-wrapping envelope includes a face panel, a back panel integrally coupled with the face panel, an expandable side panel coupled to both the face the back panels, an enclosure panel having an integral coupling to one of the panels consisting of: the face, the back, and the side panels, and/or a releasable coupling to one of the panels not integrally coupled to the enclosure panel, a releasably couplable area, releasably couplable to the enclosure panel, a nametag area; and/or a releasably couplable accessory area, releasably couplable to an accessory.

The nametag area may include an erasably writable surface or a pocket and window. The pocket and window may include a light penetrable area of the face panel and a nametag panel coupled to a side of the face panel that faces the back panel, wherein the coupling includes overlapping the nametag panel and the light penetrable section, an area between the light penetrable section and the nametag panel is detached, and at least one edge of the nametag panel is detached from the face panel.

The enclosure panel may be coupled to the back panel. The enclosure panel may be releasably couplable to the front panel. The enclosure panel releasable coupling may include a hook-and-loop fastener.

The releasably couplable accessory area may include a release liner. The releasably couplable accessory area may include a non-rip material.

The gift-wrapping envelope may include an audio label with a sound reproduction unit, wherein, upon activation, the sound reproduction unit converts stored signals to audible sounds. The activation may be by opening the envelope. The activation may be by decoupling of the enclosure panel from a releasably couplable area.

The expandable sides may include a fold extending substantially co parallel to an edge of the face panel to which the side panel integrally couples.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an front elevation view of the gift-wrapping envelope according to one embodiment of the invention;

FIG. 2 illustrates a back elevation view of the gift-wrapping envelope according to one embodiment of the invention;

FIG. 3 illustrates a front plan view of the gift-wrapping envelope according to one embodiment of the invention;

FIG. 4 illustrates an exploded view of a nametag area according to one embodiment of the invention;

FIG. 5 illustrates a front elevation view of the gift-wrapping envelope according to one embodiment of the invention; and

FIG. 6 illustrates a front plan view of the gift-wrapping envelope according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

The Envelope

The envelope of the present invention includes a face panel, a back panel, an expandable side panel, an enclosure panel, a nametag area, and a releasably couplable accessory area. The enclosure panel may be an enclosure section of one of the other panels. The expandable side panel may be a section of one of the other panels. The envelope may include an audio label. The face panel and the back panel may be integrally coupled at at least one point. The expandable side panel includes at least two portions. A first portion is integrally coupled to the face panel, and the second portion is integrally coupled to the back panel. The enclosure panel is integrally coupled to the face panel, back panel, or expandable side panel. The enclosure panel is releasably couplable to one of the panels to which it is not integrally coupled.

The panel to which the enclosure panel is releasably couplable may include an area to which the enclosure panel is releasably couplable. The releasable coupling may include any means for releasable coupling known in the art. Some non-limiting examples of releasable coupling includes hook-and-loop fasteners, snap fasteners, button fasteners, magnets, buckles, ties, hook-and-eye fasteners, releasable adhesives, adhesive releasable liners, slots, and so forth. The enclosure panel may include an area that corresponds with the releasable coupling area on the panel to which the enclosure panel is not integrally coupled.

For example, if the enclosure panel is integrally coupled to the back panel, and the face panel has an adhesive releasable liner, the enclosure panel may have an adhesive. The adhesive of the enclosure panel may coordinate with the release liner of the face panel such that the area of the enclosure panel with adhesive releasably couples with the release liner. If it is desired to open the envelope, the releasable coupling between the enclosure panel and the face panel is facilitated by the adhesive releasable liner on the face panel. In another example, the face panel may include an area with the loop portion of a hook-and-loop fastener, and the enclosure panel may include the hook portion of a hook-and-loop fastener. As above, the hook portion and the loop portion of the hook-and-loop fasteners releasably couple such that the envelope may be opened and closed as desired.

In one embodiment, the enclosure panel is integrally coupled to the face panel or the back panel in a manner such that when it is releasably coupled to the panel to which it is not integrally coupled, it substantially restricts contents of the gift-wrapping envelope from exiting the gift-wrapping envelope. In one embodiment the face and back panels are in substantially rectangular shape. An edge of the face panel is integrally coupled to a corresponding edge of the back panel. A first side panel is integrally coupled to corresponding edges of face and back panels that are proximate to the integrally coupled edges of the face and back panel. A second side panel is integrally coupled to the face and back panels at corresponding edges that are opposite those of the first side panel. The remaining edges of the face and back panel remain uncoupled to each other. As a result, there is an aperture through which articles may be placed inside of the envelope. The enclosure panel is configured to substantially restrict the articles from exiting through the aperture of the envelope.

One particular advantage to the releasably couplable enclosure panel is that it allows the envelope to be re-used. In typical prior art envelopes, an enclosure panel is adhered to the face panel such that opening of the envelope requires destruction of the envelope. Accordingly, typical prior art envelopes cannot effectively be re-used after they have been opened. However, the releasably couplable enclosure panel allows for the opening of the envelope without destruction of the envelope. The envelope may then be re-used.

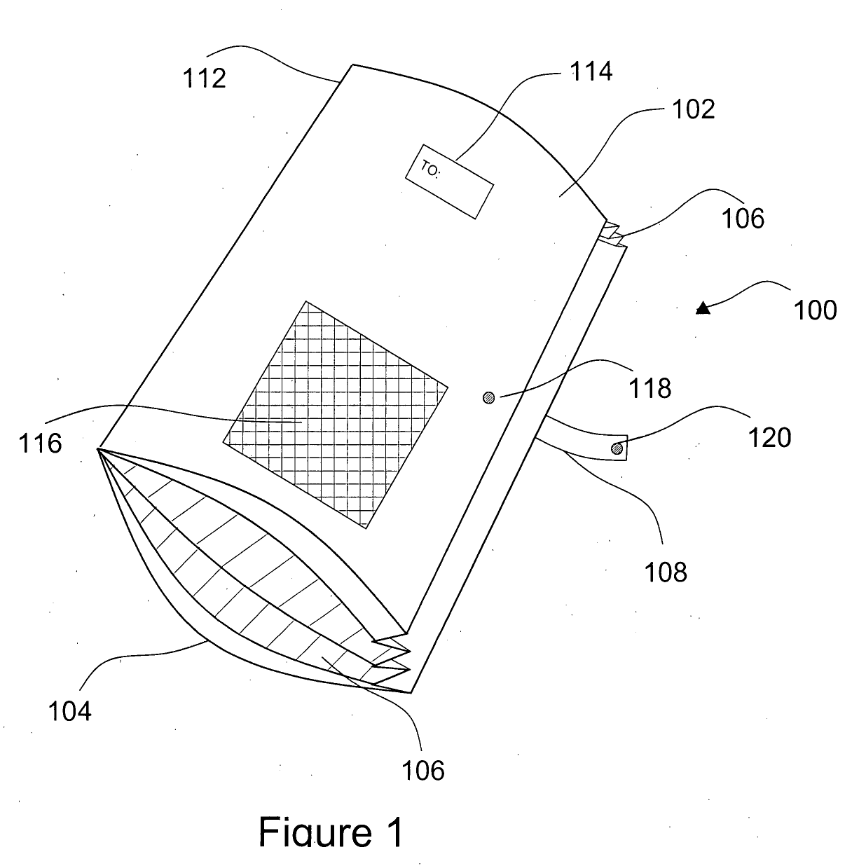

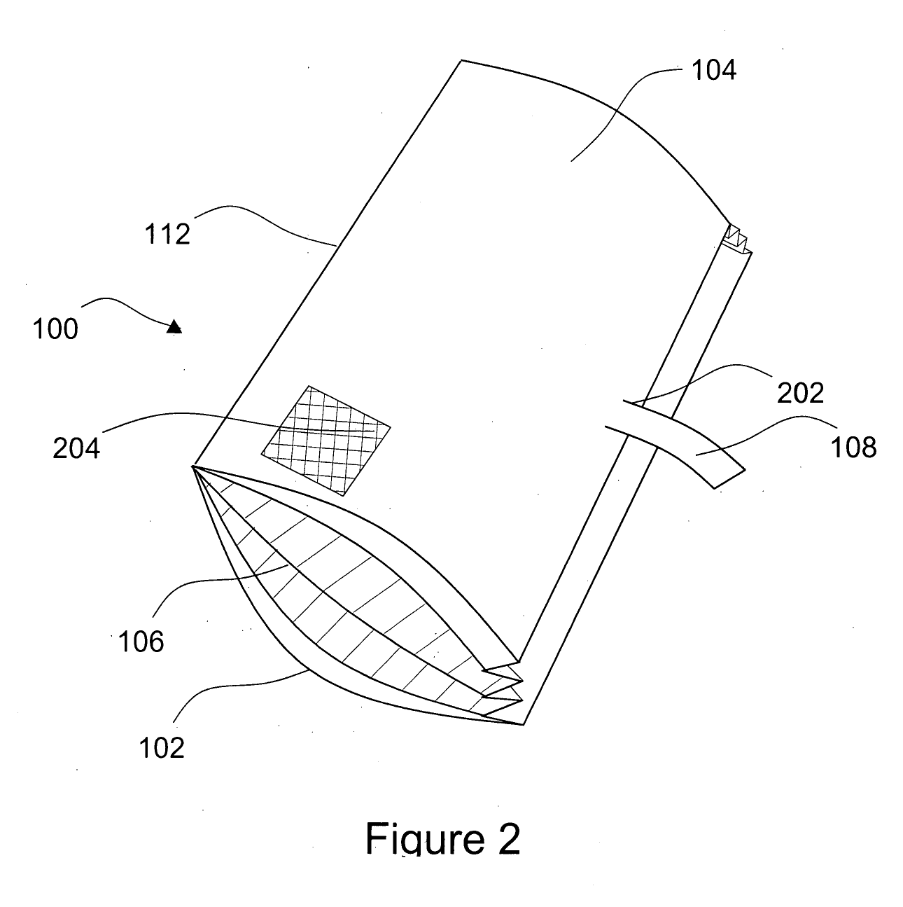

As one example of one embodiment of the gift-wrapping envelope 100, FIGS. 1 and 2 illustrate front and back elevation views, respectively, of the envelope. In this embodiment, the gift-wrapping envelope 100 includes a face panel 102, a back panel 104, two side panels 106, and an enclosure panel 108. There is a coupling 112 between the face panel 102 and the back panel 104. The face panel 102 includes a w releasably couplable area 118 to couple with the enclosure panel 108. The side panels 106 are coupled to the face panel 102 and the back panel 104. In this embodiment, the face panel 102 and the back panel 104 are in a generally rectangular shape. The side panels 106 have separate portions that are each integrally coupled to the face panel 102 and back panel 104. The side panels 106 are coupled to edges of the face panel and back panel that are not part of the coupling 112 between the face panel 102 or the back panel 104. The side panels 106 are coupled to opposite edges of the face and back panels.

The gift-wrapping envelope 100 of this embodiment also includes an enclosure panel 108 that is coupled to the back panel 104. The enclosure panel 108 includes a releasably couplable area 120 configured to couple to the releasably couplable area 118 on the face panel 102 that is designed to couple with the enclosure panel 108. The enclosure panel 108 is integrally coupled 202 to the back panel 104.

In operation of this embodiment, items may be placed into the envelope through the edges of the face panel 102 and the back panel 104 that are not coupled to each other or to the side panels 106. The enclosure panel 108 may then be releasably coupled with the face panel to inhibit the items placed in the envelope from exiting the envelope until the enclosure panel 108 is uncoupled from the face panel 102.

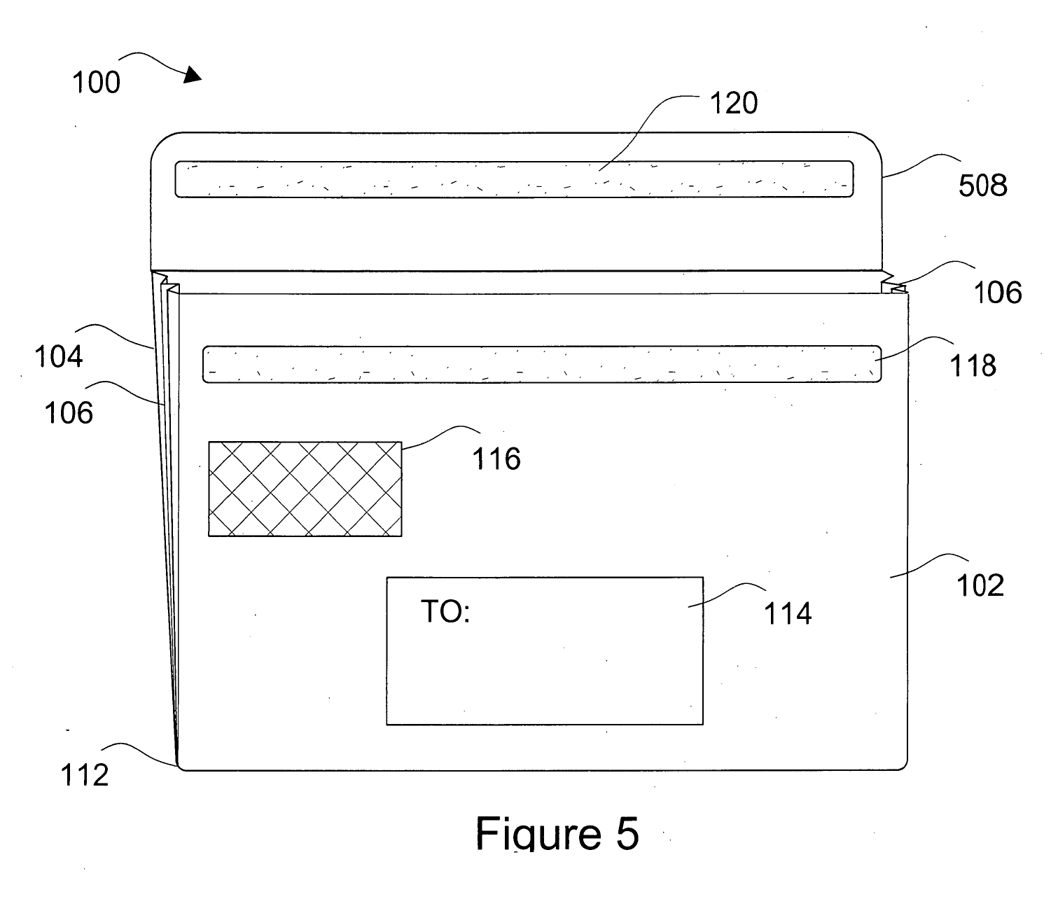

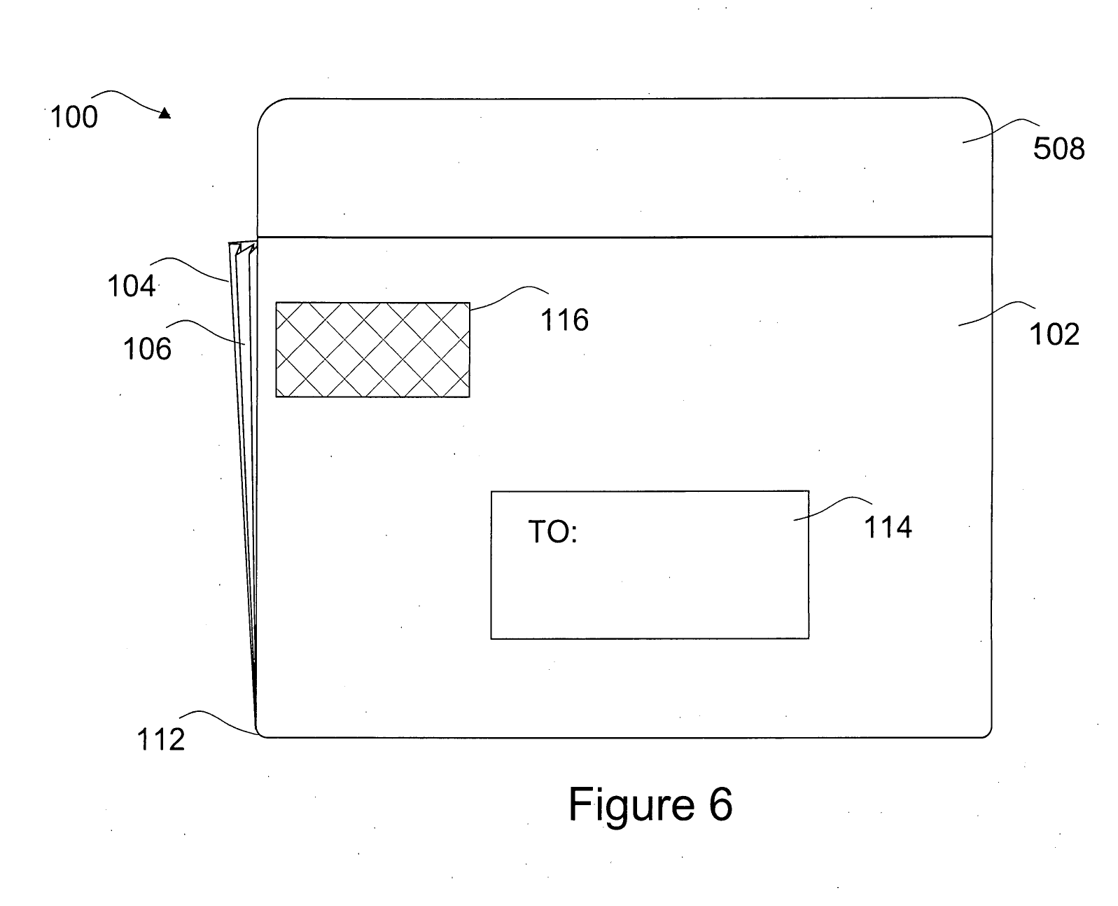

The enclosure panel may be of any shape and size and material known in the art that facilitates substantial closure of an open edge of the gift-wrapping envelope. For example, the enclosure panel 108 in FIGS. 1, 2, and 3, does not span an entire edge of the face panel 102 or the back panel. In another example, FIGS. 5 and 6 are front and back elevation views of the gift-wrapping envelope according to two embodiments of the invention with enclosure panels 508 that span substantially an entire edge of the face panel 102 or the back panel 104, respectively.

Turning now to another embodiment of the envelope, FIG. 5 illustrates an elevation view of a gift-wrapping envelope 100. In this embodiment, the enclosure panel 508 is integrally coupled to the back panel 104 of the gift-wrapping envelope 100. In this embodiment, the face panel 102 includes a releasably couplable area 118 designed to couple with the enclosure panel 508. The enclosure panel 508 includes a corresponding releasably couplable area 120. The face panel 102 and the back panel 104 are integrally coupled along at least one edge 112. The gift-wrapping envelope 100 also includes two side panels 106. The side panels 106 have separate portions that are individually and integrally coupled to the face panel 102 and back panel 104. The side panels are coupled to edges of the face panel and back panel that are not part of the coupling 112 between the face panel 102 or the back panel 104.

Turning now to yet another embodiment, FIG. 6 illustrates an elevation view of the gift-wrapping envelope 100. In another embodiment, the enclosure panel 508 is integrally coupled to the face panel 102 of the gift-wrapping envelope 100. In this embodiment, the back panel 104 includes a releasably couplable area designed to couple with the enclosure panel 508. The enclosure panel 508 includes a corresponding releasably couplable area. The face panel 102 and the back panel 104 are integrally coupled along at least one edge 112. The gift-wrapping envelope 100 also includes two side panels 106. The side panels 106 have separate portions that are each integrally coupled to the face panel 102 and back panel 104. The side panels 106 are coupled to edges of the face panel and back panel that are not part of the coupling 112 between the w face panel 102 or the back panel 104.

The face panel, back panel, side panel, and enclosure panels of any embodiment may be formed of any material known in the art. Suitable materials for these panels may include, for example, woven materials, non-woven materials, papers, polymers, plastics metals, metal foils, composite materials, and so forth. The material may be coated with, for example, a protective and/or colored coating. The material may be printed with visual and/or textural designs.

In one embodiment, the side panel or side panels are expandable. Expandability of the side panel my increase the selection of contents for the gift-wrapping envelope. Gift-wrapping envelopes may be used to enclose a card, letter, gift, or other article. At times, the intended contents of a gift-wrapping envelope may be larger than the vacant volume between the face and back panels. This problem may be solved using expandable sides. Any means known in the art for making the sides expandable may be used in this invention. In one embodiment, the sides are expandable by means of accordion folds. The accordion folds may run parallel to the edges of the face and back panels to which the side panels are integrally coupled. The accordion folds may include one or more folds. The accordion folds may be configured to expand when the face panel and back panel are pulled apart from each other, resulting in an increase of the volume defined by the face panel, back panel, and side panel. In another embodiment, the side panels may be formed from an expandable or extendable material. In another embodiment, the side panels may be formed from two or more pieces that may be slideable within each other, as in an extendable antenna.

The face panel and the back panel are integrally coupled on at least one edge. This integral coupling may be any known in the art such that the coupling substantially restricts the contents of the envelope from coming out of the envelope. This integral coupling may be any known in the art. In one embodiment, the face panel and the back panel are formed from a single piece of material, wherein the integral coupling between the face panel and the back panel comprises at least one fold. In another embodiment, the integral coupling may include the use of an adhesive, mechanical fastener such as staples, brads, folding, and so forth, lamination, and so forth. The integral coupling may include the use of at least one more panel integrally attached to the edges of the face panel and the back panel.

Nametag Area

The gift-wrapping envelope of this invention includes a nametag area. The nametag area may be configured to selectively display writings or other indicia. As illustrated in FIGS. 1, 5, and 6, in several embodiments the nametag area may be placed on the face panel 102. In one embodiment, the nametag area 114 includes an erasably writable surface. The erasably writable surface includes an area that when written upon, the writing is erasable. One particular advantage to a nametag area that is erasably writable is that the envelope may be re-used even though markings have been previously made in the nametag area. Typically, special markings indicating, for example, the intended recipient of the envelope are made on an envelope. However, re-use of prior art envelope may be inhibited because of the markings to the envelope. The present embodiment of this invention is therefore beneficial in that the nametag area may be marked and erased when it is desirable to re-use the envelope.

The nametag area may be only selectively erasable. In one embodiment, the nametag area is erasably writeable only if written upon with a certain type of medium. One example of such erasably writable surface includes a dry erasable material. Dry erasable material is any material that may be erasably marked using a dry-erase marker. In another example, the erasably writable nametag is formed from material that is erasably writable to crayon. Any material known to be writable and erasable to a crayon may be used in this example. In another example, nametag area is erasably writable using a wet-erase medium. A wet-erase medium is any that when the medium is marked by the proper marking device, it may only be erasable upon wetting by a proper wetting substance. In one example, the nametag area is formed from a wet-erasable medium and marked with a water-soluble marker that is wet-erasable with water. The markings made on the nametag area in this example are erasable upon application of water to the markings. In yet another example, the nametag area is erasable upon rubbing with, for example, a cloth, paper towel, or other wet or dry textile.

The nametag area may be formed by integrally coupling a substrate onto a panel. The substrate may include any known in the art that allows for erasable writing. Some non-limiting examples of such substrates may include polymer, metal, glass, lacquer, and so forth. The substrate may be integrally coupled to the panel using any technique known in the art. Some examples of integrally coupling the nametag area to the panel may include adhesion, lamination, coating, taping, and so forth.

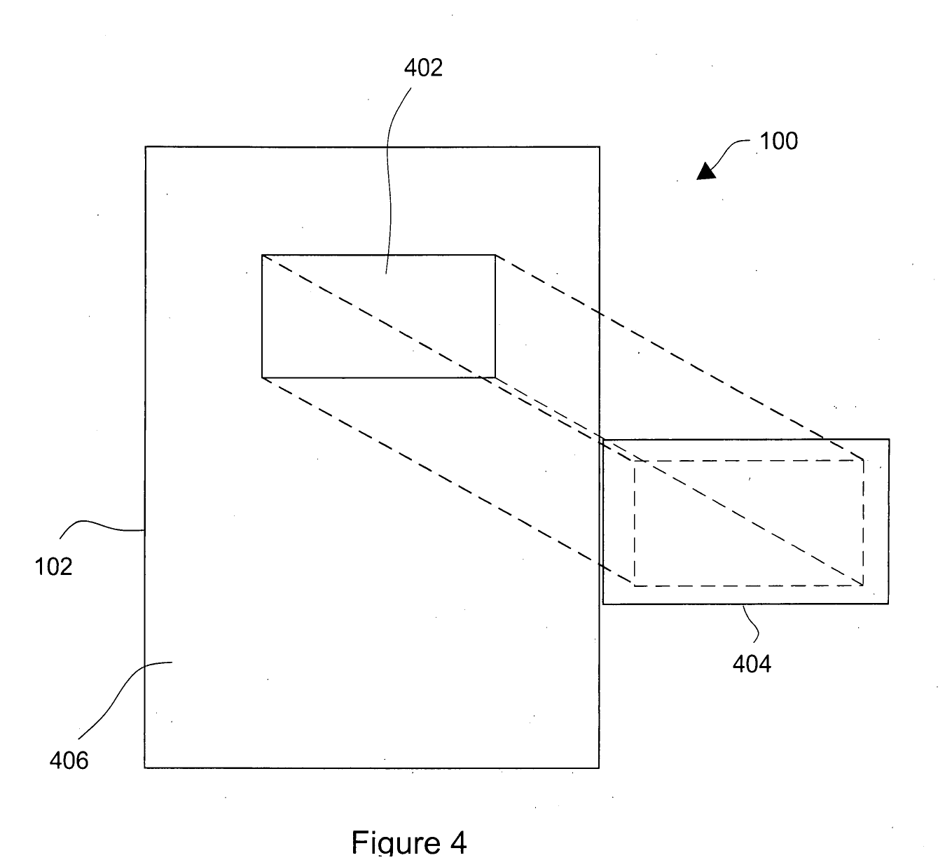

In an alternative embodiment the nametag area includes a slot and a light penetrable area. The light penetrable area is an area allowing lest a substantial amount of light to pass such that writings may be viewed through the light penetrable area. In this embodiment, an article bearing a writing may be placed into the nametag area by insertion through the slot. The writings may then show through the window. FIG. 4 illustrates an exploded view of the nametag area 114 according to one embodiment of this invention. In this embodiment, the face panel 100 includes a light-penetrable area 402. A nametag panel 404 that is larger in dimension than the light-penetrable area 402 is integrally coupled to the back face of the face panel 406. The back face of the face panel 406 is the face that faces the inside of the gift-wrapping envelope.

The nametag panel 404 is integrally coupled to the back face of the face panel 406 such that an area between the nametag panel 404 and the light penetrable area 402 remains uncoupled. This area is uncoupled such that, for example, an article bearing writing may be inserted between the light penetrable portion 402 and the nametag panel 404. Further, in this embodiment, at least one edge of the nametag panel 404 remains uncoupled to the back face of the face panel 406 such that an article bearing a writing may be selectively inserted or removed from the uncoupled area between the light penetrable area 402 and the nametag panel 404.

In another embodiment, the nametag area includes a pocket with a light penetrable area integrally coupled to the face panel. The pocket may be configured to allow an article to be selectively inserted and removed from the pocket. The article may bear writings such as the name of the intended recipient of the gift. The light penetrable area may be configured to allow an article to be viewed through the light penetrable area. The pocket may include a flap to resist the unwanted removal of the article.

In these embodiments, the light penetrable area may include any light-penetrable material known in the art. In one embodiment, the light penetrable area is devoid of any material, thus making a window. In another embodiment, the light penetrable area may selectively allow writings to be viewed only if the article bearing writings is in contact with the light penetrable area. Some examples of light-penetrable material include polymer, paper, glass, and so forth.

Releasably Couplable Accessory Area

The gift-wrapping envelope includes a releasably couplable accessory area. In one embodiment, the releasably couplable accessory area is designed to prevent ripping of the envelope upon the removal of an accessory. One particular advantage to a gift-wrapping envelope with a releasably couplable accessory area that resists ripping of the envelope upon de-coupling of the accessory is that the envelope may be re-used. For example, if an accessory, such as a bow with an adhesive, is applied to a typical gift-wrapping envelope, removal of the accessory may cause the envelope to rip. Often, a user may wish to re-use, re-gift, or keep a gift-wrapping envelope, and does not or cannot do so if it is ripped or torn. For this invention, an area is releasably couplable if it allows for the release of a coupled element without tearing, destroying, or otherwise defacing the panel to which the element is releasably coupled.

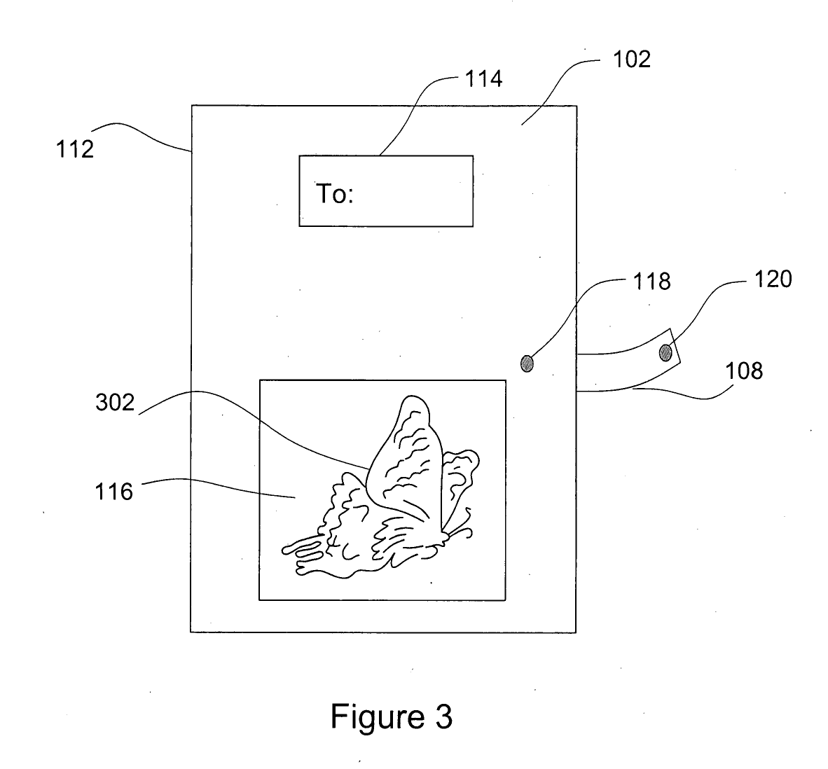

The releasably couplable accessory area may be located on any panel of the gift-wrapping envelope. As illustrated in FIGS. 1, 2, 3, 5, and 6, the releasably couplable accessory area 116 may be located on the face panel 102. FIG. 3 illustrates a front plan view of the gift-wrapping envelope 100 according to one embodiment of the invention that includes a releasably couplable accessory area 116. This embodiment shows an accessory 302 releasably coupled to the releasably couplable accessory area 116.

In one embodiment, the releasably couplable accessory area includes a release liner. The release liner may be configured to allow for the release of an adhesive from the release liner. The release liner may be any known in the art. The liner should also be capable of being placed in intimate contact with an adhesive and the adhesive subsequently removed. In one embodiment, the removal will not damaging the adhesive layer or the panel to which the release liner is coupled. The adhesive may be any adhesive known, such as a pressure-sensitive adhesive, a temperature-sensitive adhesive, a curable adhesive, and so forth. Non-limiting examples of liners include 3M™ Flouropolymer Release from Minnesota Mining & Manufacturing Company (3M) of St. Paul, Minn.

In another embodiment, the release liner includes a mechanically releasable liner. Any mechanically releasable liner known in the art may be used. For example, the liner may be the hook portion of a hook-and-loop fastener, and the accessory may include the loop portion of a hook-and-loop fastener. In another example, the liner may include the loop portion of a hook-and-loop fastener, and the accessory may include the hook-portion of a hook-and-loop fastener. In another example, the mechanically releasable liner may include a snap, button, magnet, buckle, tie, hook-and-eye, releasable adhesive, slot, and so forth.

In another embodiment, the releasably couplable accessory area comprises a material configured to resist destruction of the panel to which the releasably couplable accessory area is coupled upon removal of the accessory. The releasably couplable accessory area of this embodiment may reinforce the panel to which it is applied. In one embodiment, the releasably couplable accessory area includes a woven material resistant to tearing. In another embodiment, the releasably couplable accessory area includes a non-woven material resistant to tearing. In another embodiment, the releasably couplable accessory area includes a polymer resistant to tearing. One non-limiting example of a material resistant to destruction upon the removal of an accessory is Nylon Ripstop, available from Outdoor Wilderness Fabrics, Inc., of Caldwell, Id.

The releasably couplable accessory area of any of the embodiments may be integrally coupled to the gift-wrapping envelope in any manner known in the art. For example, the releasably couplable accessory area may be adhered to the gift-wrapping envelope. The adhesion may be by any means known in the art. For example, the adhesion may be by a pressure-sensitive adhesive, a temperature-sensitive adhesive, a curable adhesive, and so forth. The releasably couplable accessory area may be integrally coupled to the gift-wrapping envelope using mechanical fasteners such as staples, brads, and so forth. The releasably couplable accessory area may include a coating on the gift-wrapping envelope.

Audio Label

The gift-wrapping envelope of the current invention may include an audio label. The audio label may be any that is known in the art. In one embodiment, the audio label may include an audio device powered by a photovoltaic cell as described in U.S. Pat. No. 5,905,429, incorporated herein by reference. The audio label of this embodiment includes a circuit board substrate, an adhesive layer attached to the substrate and a photovoltaic cell attached to the substrate. The audio label also includes a sound-storing, sound-retrieving microchip attached to said circuit board substrate and connected to said photovoltaic cell so that said photovoltaic cell provides power to said microchip, said microchip being adapted to have audible sounds pre-recorded thereon in the form of signals which said microchip, upon activation, can communicate to replay said audible sounds. Further, the audio label of the present embodiment includes a sound reproduction unit attached to said circuit board substrate and connected to said microchip so that when said microchip communicates signals to said sound reproduction unit, said signals are converted into audible sounds.

The sound reproduction unit may include any that is known in the art. In one embodiment, the sound reproduction unit is small enough to fit on the face of the envelope. For example, the sound reproduction unit may be an electromagnetic microspeaker. In another example, the sound reproduction unit may be a piezoelectric speaker. In either of the above examples, the sound reproduction unit may attach to and use a component of the gift-wrapping envelope as a diaphragm of the sound reproduction unit.

In another embodiment, the audio label includes a battery or other energy source. The battery or other energy source may be used to power the electrical components of the audio label. Any battery or energy source known in the art may be used.

The audio label may be integrally coupled with any panel of the gift-wrapping envelope. FIG. 2 illustrates one embodiment of the gift-wrapping envelope 100 wherein the audio label 204 is integrally coupled with the back panel 104 of the gift-wrapping envelope 100. The audio label 204 may be placed at any location on the back panel 104. The placement of the audio label 204 may depend on what kind of activation is necessary to activate the audio label 204. For example, if the audio label is activated by the expanding of the side panels 106, then placement proximate to a side panel 106, as illustrated in FIG. 3 may be desired.

In one embodiment, the audio label is integrally coupled with the envelope. The coupling may be by any means known in the art. For example, the coupling may be by adhesive, tape, lamination, heat bonding, staples, brads, inserting into slots or folds in the envelope, and so forth.

### Alternative Embodiments

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although several panels are described in the above description, it is within the scope of this invention that all of the panels may be formed from one continuous piece of material. As described above, the face panel and the back panel may be formed from a single piece of material, with a fold between the two forming the integral coupling of the face and back panels. Likewise, the side panel or panels may be formed from the same piece of material as the face and/or back panels. For example, a face panel may be formed with “wings” on a side not integrally coupled to the back panel. When folded and attached to the back panel, the wings then become the side panels. The “wings” may be folded with at least one fold running parallel to the edge of the face panel from which the “wings” extend thus creating accordion-type folds. These accordion-type folds allow for the side panels to be expandable.

Further, the enclosure panel may be formed from the same piece of material as the face and/or back and/or side panels. In one example, the back panel includes the enclosure panel as an extra flap, folded from an edge of the back panel to which neither the face panel nor the side panel will be integrally coupled. This folded enclosure panel releasably couples with the face panel to function as the enclosure panel.

In one other example, the face, back, side, and enclosure panels are all formed from the same piece of material. The panels may be differentiated by folds between the panels as described above. Further integral coupling of the panels may take place as described above. For example, for the “wings” as above to become side panels, the edge of the “wing” that is not separated from the back panel with a fold must be integrally coupled to the face panel. This integral coupling may be by any means known in the art. Such means may include, for example, use of an adhesive, lamination, heat bonding, staples, folds, brads, and so forth.

Additionally, although the figures illustrate that the face panel and the back panel integrally couple directly together, any integral coupling between the face panel and the back panel is envisioned. For example, the face panel may integrally couple to an extension panel, which integrally couples to the back panel. In another example, where the face panel and the back panel are formed from a single piece of material, there could be two substantially parallel folds running parallel to the coupled edges of the face and back panels. The two folds would then create an extension panel between the face panel and the back panel.

Though the description includes a nametag area that may be an erasably writable surface or a window and pocket, other embodiments are envisioned. For example, the nametag area may include merely a window. If the nametag area were merely a window, at least a part of the contents of the gift-wrapping envelope may be visible through the window. The nametag area may include combinations of the described features. For example, the window may be erasably writable. In another example, an erasably writable surface may be visible through a window. In this last example, the window may serve to protect the erasably writable surface from accidental erasure.

In at least one embodiment, the contents of the envelope may be visible through the nametag window. The contents may bear a message to the intended recipient. The contents may bear writings to entice the intended recipient to open the envelope. The envelope may be of dimensions such that it is capable of enclosing a greeting card, full-size sheets of paper, a gift, or so forth. This invention is not meant to be limited by the contents or intended contents of the envelope.

It is expected that there could be numerous variations of the design of this invention. Although the figures and some embodiments describe a rectangular-shaped gift-wrapping envelope, it is within the scope of this invention that any shape capable of enveloping a contained article may be used. For example, if a triangle-shaped envelope is desired, the face and back panels may be in the shape of a triangle. One edge of the face panel may be integrally coupled with one corresponding edge of the back panel. One other edge of the face panel may be integrally coupled with a side panel that is in turn integrally coupled with a corresponding edge of the back panel. One edge of the face panel may remain uncoupled from the back panel. The enclosure panel may be coupled to the face or back panel and releasably couplable to the front panel. The general shape of the envelope may include, for example, rectangular, triangular, circular, pentagonal hexagonal, heptagonal, octagonal, nonagonal, decagonal, and so forth. In one embodiment, no matter the shape, only one edge of the face panel integrally couples to one edge of the back panel. Other sides that are to be coupled are coupled by expandable side panels.

For example, if the face panel and the back panel are in generally a hexagonal shape, corresponding edges of the face and back panel are integrally coupled. The edge of the face panel opposite of the integrally coupled edge remains uncoupled to the corresponding edge of the back panel. The other four edges of the face panel are integrally coupled to side panels, which are integrally coupled to corresponding edges of the back panel.

The releasably couplable accessory area may be configured to accept and release any accessory known in the art, so long as the area retards the ripping, destruction, or other defacing of the envelope upon removal of the accessory. Though the above description illustrates that the accessory may be a bow, the accessory may include any accessory known in the art. For example, the accessory may include ribbons, adhesive stickers, emblems, badges, address labels, miniature characters, tissues, tags, wraphia, ornaments, and so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A gift-wrapping envelope, comprising:
an envelope which includes:
a void; and
an expandable section;
an enclosure section releasably couplable upon closure;
a releasably couplable area releasably couplable to the enclosure section;
an accessory releasably couplable area releasably couplable to an accessory; and
a nametag area.

2. The gift-wrapping envelope of claim 1, further comprising an audio label.

3. The gift-wrapping envelope of claim 1, wherein the nametag area comprises an erasably writable surface.

4. The gift-wrapping envelope of claim 1, wherein the nametag area comprises a pocket and window.

5. The gift-wrapping envelope of claim 1, wherein the releasably couplable area releasably couplable to the enclosure section comprises hood-and-loop fastener.

6. The gift-wrapping envelope of claim 1, wherein the accessory releasably couplable area comprises a non-rip material.

7. The gift-wrapping envelope of claim 1, wherein the expandable section includes a fold extending substantially parallel to an edge of the gift-wrapping envelope.

8. A gift-wrapping envelope, comprising:
a face panel;
a back panel integrally coupled with the face panel;
an expandable side panel coupled to both the face the back panels;
an enclosure panel having
an integral coupling to one of the panels consisting of: the face, the back, and the side panels; and
a releasable coupling to one of the panels not integrally coupled to the enclosure panel;
a releasably couplable area, releasably couplable to the enclosure panel;
a nametag area; and
a releasably couplable accessory area, releasably couplable to an accessory.

9. The gift-wrapping envelope of claim 8, wherein the nametag area includes an erasably writable surface.

10. The gift-wrapping envelope of claim 8, wherein the nametag area comprises a pocket and window.

11. The gift-wrapping envelope of claim 10, wherein the pocket and window comprises:
a light penetrable area of the face panel; and
a nametag panel coupled to a side of the face panel that faces the back panel, wherein:
the coupling includes overlapping the nametag panel and the light penetrable section;
a detached area between the light penetrable section and the nametag panel; and
at least one edge of the nametag panel detached from the face panel.

12. The gift-wrapping envelope of claim 8, wherein the enclosure panel includes coupling to the back panel.

13. The gift-wrapping envelope of claim 8, wherein the enclosure panel comprises releasably couplable to the front panel.

14. The gift-wrapping envelope of claim 8, wherein the enclosure panel releasable coupling comprises a hook-and-loop fastener.

15. The gift-wrapping envelope of claim 8, wherein the releasably couplable accessory area comprises a release liner.

16. The gift-wrapping envelope of claim 8, wherein the releasably couplable accessory area comprises a non-rip material.

17. The gift-wrapping envelope of claim 8, further comprising an audio label including a sound reproduction unit, wherein, upon activation, the sound reproduction unit converts stored signals to audible sounds.

18. The gift-wrapping envelope of claim 17, wherein the activation comprises an act of opening the envelope.

19. The gift-wrapping envelope of claim 17, wherein the activation comprises an act of de-coupling the enclosure panel from a releasably couplable area.

20. The gift-wrapping envelope of claim 8, wherein the expandable sides comprises a fold extending substantially parallel to an edge of the face panel to which the side panel integrally couples.
